(19) United States
(12) Patent Application Publication
(10) Pub. No.: US 2008/0166474 A1
(43) Pub. Date: Jul. 10, 2008

(54) CONDUCTIVE COMPOSITE PARTICLE, METHOD OF MANUFACTURING THE SAME, ELECTRODE USING THE SAME, LITHIUM ION SECONDARY BATTERY

(76) Inventors: Masahiro Deguchi, Osaka (JP); Mitsuru Hashimoto, Nara (JP); Toyokazu Ozaki, Nara (JP); Akira Taomoto, Kyoto (JP)

Correspondence Address: MCDERMOTT WILL & EMERY LLP, 600 13TH STREET, NW, WASHINGTON, DC, 20005-3096, US

(21) Appl. No.: 12/050,637

(22) Filed: Mar. 18, 2008

Related U.S. Application Data
(63) Continuation-in-part of application No. PCT/JP2007/052262, filed on Feb. 8, 2007.

(30) Foreign Application Priority Data
Feb. 17, 2006 (JP) 2006-040551

(51) Int. Cl. B05D 5/12; B05D 7/00

(52) U.S. Cl. 427/122; 427/215

(57) ABSTRACT

In a manufacturing method of a conductive composite particle, a conductive composite particle is manufactured that is formed of an active material particle having a region capable of electrochemically inserting and desorbing lithium and a carbon layer joined to the particle surface. In the carbon layer, fine metal particles are dispersed. This method has the following three steps. In the first step, a polymer material containing the metal element composing the fine metal particles is prepared. In the second step, the active material particle surface is coated with the polymer material containing the metal element. In the third step, a carbon layer having a porous structure including a fibrous structure is formed as the surface layer section from the polymer material by a treatment where the active material particle coated with the polymer containing the metal element is heated in an inert atmosphere to carbonize the polymer material.

### BACKGROUND OF THE INVENTION

1. Field of the Invention

The present invention relates to a conductive composite particle used for active material or the like capable of charging and discharging lithium (Li), and more particularly to a conductive composite particle of which surface layer is formed of a carbon layer having a fibrous structure containing fine metal particles and a porous structure. An electrode using the conductive composite particle of the present invention is suitable for a lithium ion secondary battery or capacitor having high initial charge-discharge characteristics and low cycle degradation.

2. Background Art

With the advancement of portable electronic instruments, non-aqueous electrolyte secondary batteries smaller in size, lighter in weight, and higher in energy density have been demanded strongly. Presently, as a negative electrode active material in a lithium ion secondary battery, a carbon material such as graphite is generally in practical use. A calculated theoretical capacity density of the graphite used as the negative electrode active material is 372 mAh/g, because one lithium (Li) atom can be inserted with respect to six carbon (C) atoms. However, capacity loss or the like is caused by irreversible capacity or the like, so that a discharge capacity density of the lithium ion secondary battery using graphite as the negative electrode material is actually about 300 mAh/g through 330 mAh/g.

Therefore, in order to develop a lithium ion secondary battery having higher energy density, use of the negative electrode active material having high theoretical capacity density has been studied. For instance, silicon (Si), tin (Sn), germanium (Ge), which can form alloys with lithium, and an oxide thereof have been expected. These materials generally have low electron conductivity, so that the internal resistance of the battery increases disadvantageously. Therefore, the electron conductivity is secured and the internal resistance of the battery is reduced by adding, as a conductive agent, a conductive material such as fine metal particles of silver or the like, fine graphite powder, or carbon black (CB) and by forming a coating layer made of a conductive material on the surface of the material having low electron conductivity.

In order to form a stable electron conductive network among negative electrode active materials and improve the cycle characteristics of the battery, it is proposed that wire-like carbon is grown on the surface of the negative electrode active material particle by vapor synthesis (Patent documents 1 through 3). For instance, Patent document 1 discloses that Ni particles or Co particles are formed on the graphite used for a negative electrode active material and then carbon fiber is grown using the particles as catalysts by the vapor synthesis method. Another method is disclosed in which the surface of the graphite is temporarily coated with polymer (polyvinyl alcohol) as an amorphous carbon precursor, they are heated to produce an amorphous film, and the vapor-synthesized carbon fiber is grown.

The negative electrode active material considered as an alternative to a carbon material such as graphite has low conductivity as discussed above, and the charge-discharge characteristics of a lithium ion secondary battery having a negative electrode singly made of such a material is insufficient. Therefore, these problems are addressed by adding a conductive agent or coating the surface of the active material with a conductive material (for example, carbon film). However, these structures have the following problem. Expansion and contraction of the active material are caused by lithium alloying reaction or lithium absorbing-desorbing reaction that occurs in the charge-discharge cycle. The expansion and contraction cause gradual disconnection of an electron conductive network formed of a conductive agent or the like, and increase the internal resistance of the battery. In other words, it is difficult to achieve sufficient cycle characteristics of the lithium ion secondary battery, disadvantageously.

As a method for addressing the problem, it is proposed to form fibrous carbon on the surface of an active material particle by the vapor synthesis method. However, a large manufacturing device is required, or the productivity decreases, disadvantageously. In other words, it is difficult to easily produce a lithium ion secondary battery having sufficient cycle characteristics.

As described above, for avoiding the resistance-increasing phenomenon of an electrode in the charge-discharge cycle process of the lithium ion secondary battery, it is required to easily manufacture an active material constituting an electron conductive network that is stable in the cycle process.

Patent document 1: Japanese Patent Unexamined Publication No. 2001-196064

Patent document 2: Japanese Patent Unexamined Publication No. 2004-220910

Patent document 3: Japanese Patent Unexamined Publication No. 2004-349056

### SUMMARY OF THE INVENTION

The present invention addresses the above-mentioned problems, and improves the conductivity of an active material particle used for a negative electrode of a lithium ion secondary battery or the like. The present invention easily and productively provides a conductive composite particle capable of achieving charge-discharge characteristics having low cycle degradation, and provides an electrode and lithium ion secondary battery using it.

In order to address the conventional problems, the present invention provides a manufacturing method of the conductive composite particle that is formed of a core section and a surface layer section. The core section is formed of a particle having a region capable of electrochemically inserting and desorbing lithium (Li), and the surface layer section is formed of a carbon layer joined to the particle surface. Fine particles containing a metal element are dispersed in the carbon layer. This manufacturing method has the following steps:
a first step of preparing a polymer material that contains the metal element composing the fine particles dispersed in the carbon layer;
a second step of coating a surface of the particle with the polymer material containing the metal element; and
a third step of forming, as the surface layer section, a carbon layer having a porous structure including a fibrous structure from the polymer material by performing treatment where the particle coated with the polymer containing the metal element is heated in an inert atmosphere to carbonize the polymer material.

In order to address the conventional problems, the present invention provides a second manufacturing method of the conductive composite particle that is formed of a core section and a surface layer section. The core section is formed of a particle having a region capable of electrochemically inserting and desorbing lithium (Li), and the surface layer section is formed of a carbon layer joined to the particle surface. Fine particles containing a metal element are dispersed in the carbon layer. The second manufacturing method has the following steps:
a first step of making the particle surface support a compound that contains the metal element composing the fine particles dispersed in the carbon layer;
a second step of coating the particle surface supporting the compound that contains the metal element with a polymer material; and
a third step of forming, as the surface layer section, a carbon layer having a porous structure including a fibrous structure from the polymer material by performing treatment where the particle coated with the polymer material is heated in an inert gas atmosphere to carbonize the polymer material.

The conductive composite particle obtained by the above-mentioned manufacturing method is formed of an electrochemically active particle and a porous carbon layer that is joined to the surface of the particle. The porous carbon layer has a fibrous structure where the fine particles containing a metal element are dispersed. However, the conductive composite particle may contain another component such as a conductive polymer as long as the function of the conductive composite particle is not obstructed.

The joint between the particle as a core and the carbon layer applied to the surface of the particle may be the entire particle surface, or may be a part of the particle surface. The structure of the joint may be formed of the carbon region in the carbon layer, or formed of the fine particles containing the metal element. In any case, it is required that the particle as the core is not in contact with the carbon layer making a simple contact, but is firmly coupled to each other, and the electric connection between the particle and the carbon layer is sufficient.

This manufacturing method allows easier manufacturing of a conductive composite particle used for producing an electrode of a lithium ion secondary battery that has charge-discharge characteristics higher than the conventional art and low cycle degradation.

In addition, the carbon layer constituting the outermost surface of the conductive composite particle obtained by the manufacturing method is preferably made of carbon having a fibrous structure. Specifically, the porous carbon layer that is formed on the surface of the particle as the core and has the fibrous structure may be homogeneous overall, preferably, the percentage of fibrous carbon increases toward the surface layer of the conductive composite particle.

This structure allows a stabler electron conductive network when an electrode or the like is formed of an aggregate of the conductive composite particles.

The fibrous carbon used for the present invention is required to be flexible to some extent and to be conductive. An example of the fibrous carbon includes tube-like carbon, accordion-like carbon, plate-like carbon, herringbone-like carbon, or amorphous carbon. Especially, a laminated body of fine graphite having a graphene plane in the tilted direction with respect the fiber axis, namely a herringbone type laminated body, is preferable from the viewpoint of a production or the like, but the present invention is not limited to this.

In a general structure of each fibrous carbon used in the present invention, the fiber length is substantially between 5 nm and 100 μm inclusive, and the fiber diameter is substantially between 1 nm and 50 nm inclusive.

This structure allows manufacturing of a conductive composite particle for an electrode of a lithium ion secondary battery that has higher charge-discharge characteristics.

In the manufacturing method of the present invention, it is preferable that the conductive composite particle is an elemental substance or a compound containing at least one of elements selected from silicon (Si), tin (Sn), and germanium (Ge), or a mixture of them. Especially, it is preferable that the compound composing the particle is one of oxide, nitride, oxynitride, and carbide. An example of the particle includes a particle made of pure Si, a particle made of silicon oxide, a particle containing a silicon oxide component having Si as a principle component, or a particle including a minute amount of oxygen, nitrogen, carbon component in Si, Sn, or Ge. However, the present invention is not limited to these. This particle may be a simple crystalline or amorphous, a mixture of aggregates of fine crystalline layers, a mixture of crystalline and amorphous, or a mixture of amorphous and other amorphous.

This structure allows stable manufacturing of a conductive composite particle for a negative electrode that has charge-discharge characteristics higher than those of a carbon material such as graphite used for a conventional negative electrode.

In the manufacturing method of the present invention, it is preferable that the film thickness of the polymer material is between 0.05 μm and 10 μm inclusive. The polymer layer formed on the particle surface is partially thermally decomposed by heat treatment to be carbonized, thereby resulting in a porous carbon layer including a fibrous structure. The thickness of the carbon layer depends on the film thickness of the polymer material, so that the film thickness of the polymer material is required to be determined appropriately, corresponding to the desired thickness of the carbon layer. For manufacturing the conductive composite particle, the film thickness is substantially between 0.05 μm and 10 μm inclusive, preferably between 0.05 μm and 0.5 μm inclusive. The reason is as follows. When the polymer film thickness, namely the carbon layer thickness, is too great, the percentage of electrochemically active particles reduces overall in forming an electrode. When the polymer film thickness is too small, it is difficult to form the electron conductive network. In the manufacturing method of the present invention, when the polymer layer thickness is appropriate during carbonization by heat treatment of the polymer layer applied to the particle surface, a carbon layer having a porous structure including a fibrous structure suitable for forming the electron conductive network is easily formed. As a result, for obtaining a conductive composite particle having a greater effect, the thickness of the polymer layer determined from the above-mentioned range is suitable.

In the manufacturing method, it is preferable that the polymer material is aromatic polyimide. Especially, the polyimide material of which thermal decomposition temperature is between 400° C. and 600° C. inclusive is preferable.

In the manufacturing method, a carbon layer having desired characteristics can be easily formed on the particle surface.

In the manufacturing method, it is preferable that the metal element added to the polymer material or supported by the particle surface contains at least one selected from iron (Fe), cobalt (Co), nickel (Ni), and manganese (Mn). Especially, nickel is suitable.

An example of the method of adding the metal element to the polymer material, depending on the polymer material to be used, includes the following methods, for example:
a method of dispersing predetermined fine metal particles in the polymer;
a method of polymerizing monomer (molecule) itself preliminarily bonded to the metal element; and
a method of dissolving a compound containing a predetermined metal element in a solution-like polymer precursor and polymerizing the resultant solution. Among them, the easier and effective method is the last method of adding and dissolving a predetermined metal compound in the solution-like polymer precursor. This method facilitates the control of the added amount of the metal element, and allows the metal element to be added to the polymer in a homogeneous dispersion state. As the metal compound to be added to the solution-like polymer, nitrate of the metal element such as nickel nitrate can be easily used. However, the present invention is not limited to this.

As the method of making the particle surface support the compound containing the metal element, a method of producing aqueous solution or the like of the metal compound, applying it to the particle surface by coating or atomization, and then drying them.

This manufacturing method allows easy forming of a carbon layer having desired characteristics on the particle surface.

The ratio of the amount of the metal element mixed into the polymer layer with respect to the weight of carbon is substantially between 0.1% and 15% inclusive, preferably between 1% and 10% inclusive. The reason is as follows. When the metal element amount is too large, the percentage of electrochemically active particles reduces overall. When the metal element amount is too small, it is difficult to increase the conductivity of the porous carbon layer including the fibrous structure that is involved in forming of the electron conductive network. As a result, for obtaining a conductive composite particle having a greater effect, the metal element amount determined from the above-mentioned ranges is suitable.

The case of making the particle surface support the compound containing the metal element is alike. It is preferable to stick the metal compound to the particle surface so that the ratio of the metal element amount to the polymer material amount is substantially between 0.1% and 15% inclusive.

The manufacturing method allows easier manufacturing of a conductive composite particle used for producing an electrode of a lithium ion secondary battery that has charge-discharge characteristics higher than the conventional art and low cycle degradation.

In the manufacturing method, it is preferable that the heating temperature is between 400° C. and 1000° C. inclusive. Generally, it is preferable that the annealing temperature is lower. However, a heating temperature above a certain level is required for forming a carbon layer having a high conductive characteristic. In the manufacturing method, depending on the polymer material to be used or the kind of the metal compound to be added, the carbon layer suitable for the conductive composite particle can be formed by performing the annealing treatment at the heating temperature selected from the range of 400° C. through 1000° C.

As discussed above, a first procedure example for manufacturing the conductive composite particle of the present invention has the following steps:
(i) dissolving a metal compound in a solution-like polymer precursor;
(ii) coating a surface of a particle with the polymer precursor solution;
(iii) polymerizing the polymer precursor on the particle surface; and
(iv) annealing the particle coated with the polymer material in an inert gas atmosphere at a heating temperature that is the thermal decomposition temperature of the polymer material or higher.

A second procedure example has the following steps:
(i) coating a surface of a particle with an aqueous solution of a metal compound and drying them;
(ii) coating the particle surface with a solution-like polymer precursor;
(iii) polymerizing the polymer precursor on the particle surface; and
(iv) annealing the particle coated with the polymer material in an inert gas atmosphere at a heating temperature that is the thermal decomposition temperature of the polymer material or higher.

These procedure examples are typical, and the conductive composite particle may be produced by another procedure.

For addressing the conventional problems, the conductive composite particle of the present invention is formed of a core section and a surface layer section. The core section is formed of a particle having a region capable of electrochemically inserting and desorbing lithium (Li), and the surface layer section is formed of a carbon layer joined to the particle surface. Fine particles containing a metal element are dispersed in the carbon layer. The carbon layer contains nitrogen (N) or hydrogen (H), and has a porous structure including a fibrous structure.

In this structure, the carbon layer composing the conductive composite particle contains nitrogen (N) or hydrogen (H), but its content with respect to carbon (C) is substantially 10 ppm through 2%. Especially, it is preferable that the carbon layer contains a minute amount of nitrogen in this range.

In this structure, it is preferable that the conductive composite particle is an elemental substance or a compound containing at least one of elements selected from silicon (Si), tin (Sn), and germanium (Ge), or a mixture of them. Especially, it is preferable that the compound composing the particle is one of oxide, nitride, oxynitride, and carbide. An example of the particle includes a particle made of pure Si, a particle made of silicon oxide, a particle containing a silicon oxide component having Si as a principle component, or a particle containing a minute amount of oxygen, nitrogen, carbon component in Si, Sn or Ge. However, the present invention is not limited to these. This particle may be a simple crystalline or amorphous, a mixture of aggregates of fine crystalline layers, a mixture of crystalline and amorphous, or a mixture of amorphous and other amorphous.

This structure allows manufacturing of a conductive composite particle for a negative electrode that has charge-discharge characteristics higher than those of a carbon material such as graphite used for a conventional negative electrode.

In this structure, it is preferable that the carbon layer constituting the outermost surface of the conductive composite particle is made of carbon having a fibrous structure. In other words, the porous carbon layer that is formed on the surface of the particle as the core and has the fibrous structure may be homogeneous overall, however, it is preferable that the percentage of fibrous carbon increases toward the surface layer of the conductive composite particle.

This structure allows manufacturing of a stabler electron conductive network when an electrode or the like is formed of an aggregate of the conductive composite particles.

In this structure, it is preferable that the metal element composing fine particles dispersed in the carbon layer includes at least one selected from iron (Fe), cobalt (Co), nickel (Ni), and manganese (Mn). Especially, nickel is suitable when the porous carbon layer that composes the conductive composite particle of the present invention and includes a fibrous structure is made of a polymer material. The diameter of the fine particles used in the present invention is substantially between 1 nm and 50 nm inclusive.

In order to address the conventional problems, the electrode of the present invention is formed of a thin metal plate and a conductive material. The conductive material laminated on the thin metal plate is formed of an aggregate of the conductive composite particles produced by one of the above-mentioned manufacturing methods.

In order to address the conventional problems, the lithium ion secondary battery of the present invention has a chargeable/dischargeable positive electrode, a chargeable/dischargeable negative electrode, and a non-aqueous electrolyte, as components thereof. The negative electrode contains the conductive composite particle produced by one of the above-mentioned manufacturing methods.

This structure allows manufacturing of a lithium ion secondary battery that has charge-discharge characteristics higher than those of a conventional art and has a stable cycle characteristic, and allows manufacturing of a negative electrode used for it.

In the conductive composite particle produced by the manufacturing method of the present invention, a conductive carbon layer having the porous structure including the fibrous structure is formed on the surface of the particle having a region capable of electrochemically inserting and desorbing lithium (Li). Therefore, the electrode formed of the aggregate of the conductive composite particles has high electron conductivity. As a result, a lithium ion secondary battery having high initial charge-discharge characteristics can be obtained. Thanks to the action of the porous carbon layer that is joined to the particle surface and includes the fibrous structure, the electric connection between an electrochemically active particle and the carbon layer and the electric connection between the carbon layer and the carbon layer are maintained even when the battery is evaluated in the charge-discharge cycle characteristics. Using the conductive composite particle of the present invention, a lithium ion secondary battery having a high charge-discharge cycle characteristic can be thus obtained.

The carbon layer containing nitrogen or hydrogen that is obtained by the manufacturing method of the present invention has not only electron conductivity but also a function of electrochemically inserting and desorbing lithium, so that a lithium ion secondary battery totally having large capacity can be manufactured

### BRIEF DESCRIPTION OF DRAWINGS

FIG. 1 is a schematic sectional view showing a structure of a conductive composite particle of the present invention.

FIG. 2 is a schematic sectional view showing a structure of another conductive composite particle of the present invention.

FIG. 3 is a schematic sectional view showing a structure of yet another conductive composite particle of the present invention.

FIG. 4 shows a scanning electron microscope (SEM) image of the surface of a conductive composite particle obtained in an example 1 of the present invention.

### DETAILED DESCRIPTION OF THE INVENTION

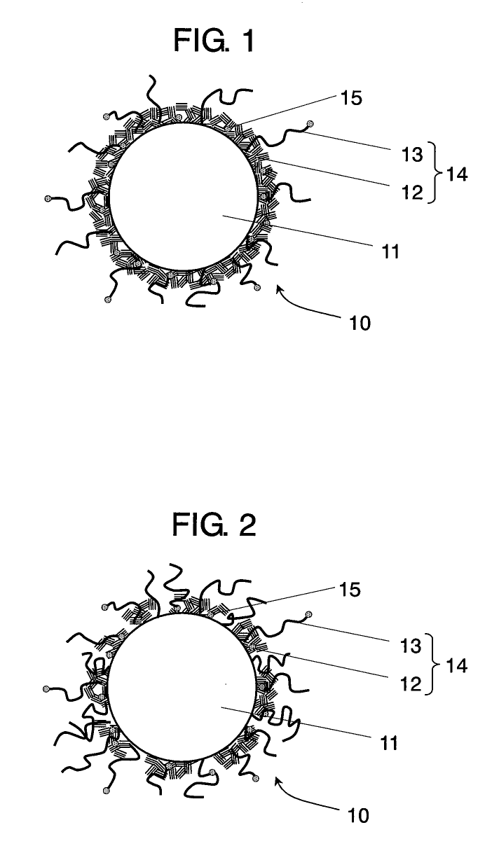

An exemplary embodiment of the present invention will be described with reference to the accompanying drawings. FIG. 1 is a schematic sectional view showing the structure of a conductive composite particle of the present invention. Conductive composite particle 10 of the present invention has the following elements:
particle 11 having a region capable of electrochemically inserting and desorbing lithium (Li) (hereinafter referred to as “active material particle 11”);
carbon layer 14 formed of porous structure 12 and fiber structure 13; and
metal or metal compound fine particles 15 dispersed in carbon layer 14 (hereinafter referred to as “fine metal particles 15”).

Active material particle 11 may be a granulated body formed of a plurality of particles, but is preferably formed of a single particle. That is because the single particle is hardly collapsed by expansion and contraction of the active material particle in the charge-discharge cycle. Even when the single particle is employed, the average diameter of active material particle 11 is preferably between 0.5 μm and 20 μm inclusive from the viewpoint of suppressing the collapse of the particle as much as possible.

Fine metal particles 15 dispersed in carbon layer 14 are not especially limited as long as they are not a metal group composing a stable carbide such as titanium (Ti) or tantalum (Ta). Preferably, a metal element whose carbonating catalytic action is active, especially one of iron (Fe), cobalt (Co) and nickel (Ni), is used. Usually, the diameter thereof is about several nm through tens nm.

The action of the metal element is divided broadly into two. The first action is catalytic action of the metal element that easily improves the quality of carbon layer 14 formed on the surface of active material particle 11 by carbonization of the polymer material. The second action functions as an active point for partially forming carbon layer 14 in fiber structure 13. When there is no fine metal particle 15, extremely high annealing treatment temperature is required for achieving the structure of the present invention, or it is difficult to form a porous carbon layer including a desired fibrous structure.

As a result, active material particle 11 is electrically connected to carbon layer 14 joined to the surface thereof. Thus, the high electron conductivity can be secured, so that a high charge-discharge characteristic is obtained. Even when the charge-discharge cycle causes expansion and contraction of the active material particle, the electric connection is easily maintained.

Hereinafter, a method of forming carbon layer 14 having a porous structure including a fibrous structure on the surface of active material particle 11 is described. In the method of forming carbon layer 14 having the above-mentioned structure, as shown in the method of the present invention, a metal compound working as a catalytic is previously mixed into the polymer material as a carbon layer precursor, and a particle coated with the polymer material is easily annealed at a heating temperature that is not lower than the thermal decomposition temperature of the polymer material. For instance, an active material particle coated with the polymer material that has an appropriate thickness and contains a metal element is placed in an electric furnace, and is annealed in an inert gas atmosphere at 400° C. through 1000° C., thereby manufacturing a conductive composite particle having a desired structure.

The annealing temperature depends on the polymer material to be used or a metal compound to be added. When the annealing temperature is 300° C. or lower, carbonization of the polymer material is insufficient. When it is 1200° C. or higher, the electrochemical function of the active material particle can be often damaged. Therefore, the annealing temperature is 300° C. through 1200° C., preferably 400° C. through 1000° C., more preferably 500° C. through 800° C.

As the polymer material applied to the particle surface, a material that is carbonized by the catalytic action of the metal element in the above-mentioned annealing temperature range can be used substantially. However, polymer whose thermal decomposition temperature is relatively low, for example polyvinyl alcohol, is not appropriate because the polymer is thermally decomposed before the catalytic action of the metal element works. When the thermal decomposition temperature of the polymer is too high on the other hand, the catalyst metal particles are coagulated before the carbonization of the polymer material is promoted, and a fibrous carbon layer is hardly formed. Therefore, polymer is suitable that has a thermal decomposition temperature of about 400° C. through 600° C. at which the metal catalyst acts efficiently. Especially, a polymer material having an imide structure in a polymer structure such as aromatic polyimide is suitable.

The aromatic polyimide as one example of the polymer material can be generally formed by polycondensation of acid anhydride and diamine. Various polyimide structures can be produced by combination of acid component and diamine component. As the acid anhydride component, pyromellitic dianhydride (PMDA), biphenyl tetracarboxylic dianhydride (BPDA), benzophenone tetracarboxylic dianhydride (BTDA) or the like can be used. As the diamine component, oxydianiline (ODA), paraphenylenediamine (PPD), benzophenonediamine (BDA) or the like can be used. For example, poly-4,4′-oxydiphenylene pyromellitic imide as a combination of them can be used as an appropriate example of the polymer material of the present invention. However, the present invention is not limited to this.

Carbon layer 14 formed on the surface of active material particle 11 is made of porous carbon containing fibrous carbon. The porous carbon region is formed on the surface of the active material particle, but the amount or porosity is not limited as long as the battery characteristics are not affected. Generally, it is optimal that the carbon region covers a substantially entire part or most part of the particle surface. FIG. 2 is a schematic sectional view showing the state where porous carbon is formed on a part of the surface of the active material particle. In this case, it is preferable that there is fibrous carbon in a part having no porous carbon. The reason is as follows. When an electrode is formed of an aggregate of conductive composite particles and an electron conductive network is established, it is preferable that the entire surface of the active material particle is covered with the fibrous carbon region. As the structure of the fibrous carbon, any of tube-like carbon, accordion-like carbon, plate-like carbon, herringbone-like carbon, and amorphous carbon can be used as long as the conductivity can be secured.

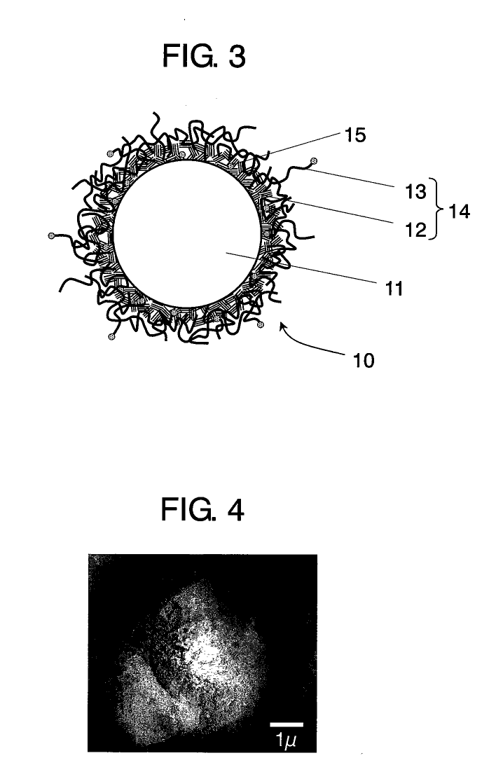

FIG. 3 is a schematic sectional view showing the state where the outermost surface of the conductive composite particle is covered with the fibrous carbon. As discussed above, when an electrode is formed of an aggregate of conductive composite particles and an electron conductive network is established, it is preferable that the outermost surface is the fibrous carbon region.

A process of forming a conductive composite particle of the present invention by the above-mentioned procedure is described briefly. When the polymer material is annealed at a heating temperature not lower than the thermal decomposition temperature, the thermal decomposition occurs, vaporized component such as hydrocarbon, carbon monoxide, or carbon dioxide is partially desorbed, and the remaining polymer component is carbonized and transformed to a carbon layer made of substantially only carbon. Generally, as the annealing temperature increases, the carbonization progresses more and the conductivity becomes higher. For completing the carbonization and exhibiting high conductivity in the annealing treatment of only polymer material, generally, annealing must be performed at 1000° C. or higher.

In contrast, when the metal element having the catalytic action for promoting the carbonization coexists, the carbonization of the polymer can be promoted by action thereof. In other words, a carbon layer of high conductivity can be formed by annealing treatment at a heating temperature lower than that for the polymer material that does not contain a metal element having catalytic action.

The thermal decomposition temperature region of the polymer material and a temperature region in which the metal element becomes catalytically active are controlled to substantially the same region, and the polymer layer thickness is set in an appropriate range. This condition allows the carbonization to be promoted, and can simultaneously form a porous carbon layer and the fibrous structure around the catalytic fine metal particles as base points. Therefore, for forming the conductive composite particle of the present structure, polymer that is thermally decomposed at 400° C. through 600° C. is appropriate, and it is difficult to obtain a porous carbon layer including the fibrous structure using a polymer material having a low thermal decomposition temperature.

Next, an electrode formed of the conductive composite particles is described. A general electrode used in a cylindrical or prismatic non-aqueous electrolyte lithium ion secondary battery is obtained by processing an electrode precursor including a current collector, which supports an electrode mixture thereon into a predetermined shape. The electrode mixture usually contains a conductive composite particle and a resin binder as components thereof. The electrode mixture can contain a conductive agent or a thickener as an arbitrary component as long as the advantage of the present invention is not obstructed. An example of the binder includes fluoroplastic such as polyvinylidene fluoride (PVDF), rubbery resin such as styrene-butadiene rubber (SBR), or rubbery resin containing acrylic acid or acrylonitrile. A preferable example of the conductive agent includes carbon black (CB) or acetylene black (AB). A preferable example of the thickener includes carboxymethyl cellulose (CMC) or the like.

The electrode mixture is mixed with a liquid component to be put into a slurry state, and the obtained slurry is applied to both surfaces of the current collector and dried. Then, the electrode mixture supported by the current collector is roll-pressed together with the current collector, and the pressed product is cut to a predetermined size, thereby forming a desired electrode. The described method is just one example, and any other method may be used for producing the electrode. The type or shape of the electrode is not limited, and a conductive composite particle can be used for the electrode of a coin type battery, for example.

Furthermore, a lithium ion secondary battery using the electrode formed of the conductive composite particle is described. An electrode group is composed of the electrode produced by the above-mentioned method, a counter electrode, and a separator. A preferable example of the separator includes a micro-porous film made of polyolefin resin. The present invention is not limited to this. The electrode group is housed in a battery case together with non-aqueous electrolyte. As the non-aqueous electrolyte, generally, non-aqueous solvent in which lithium salt is dissolved is used. As the lithium salt, which is not especially limited, LiPF₆, LiBF₄ or the like is preferably used. As the non-aqueous solvent, which is not especially limited, carbonate such as ethylene carbonate (EC), propylene carbonate (PC), dimethyl carbonate (DMC), diethyl carbonate (DEC), ethyl methyl carbonate (EMC) or the like is preferably used.

Hereinafter, the present invention is specifically described using examples and comparative examples. The following examples just describe a part of the embodiment of the present invention. The present invention is not limited to these examples.

### EXAMPLE 1

### Electrode Material A1

An example is described where aromatic polyimide is used as a polymer material to be applied to an active material particle.

Aromatic polyimide is synthesized by an organic synthesis method generally called a solution method. A specific method is as follows. Using dimethylacetamide (DMAC) as solvent, pyromellitic dianhydride (PMDA) and 4,4′-diaminodiphenyl ether (ODA) are mixed at the same mol and then made to react with each other, thereby producing 10 wt % polyamic acid solution (hereinafter referred to as “PAA solution”). For adding nickel (Ni) as a catalyst element for forming a carbon layer to the polymer material, nickel nitrate hexahydrate (Ni (NO₃)₂.6H₂O) is added to PAA solution so that the ratio of Ni to the polymer component is 10 wt %, and is stirred for several hours to be dissolved.

Then, silicon (Si) particles are mixed into Ni-added PAA solution (Ni-PAA solution), and stirred with a magnetic stirrer. Then, the solution mixed with particles is moved into a petri dish, and the petri dish is placed in a vacuum drier evacuated by a rotary pump, dried, and heated, thereby transforming the PAA into imide. The average diameter of used Si particles is 5 μm. After imidization, the obtained sheet-like sample is slightly ground with a glass mortar into a powder form. As a result, the Si particles coated with Ni-added polyimide film (Ni-PI film) are obtained. The thickness of the polyimide film applied to the Si particles is substantially 0.3 μm through 0.5 μm.

The Si particles coated with Ni-added polyimide film are filled into a carbon-made container, put into an electric furnace, and annealed for one hour at 1000° C. in an argon (Ar) gas atmosphere, thereby carbonizing the polyimide film.

As a result, a porous carbon layer is formed on the surface of each Si particle, and a fibrous carbon layer of which fiber diameter is tens nm through hundreds nm and fiber length is several μm is formed so as to cover the porous carbon layer. The amount of the formed carbon layers is 40 parts by weight per 100 parts by weight of active material particle. According to the composition analysis of the obtained carbon layers, the carbon layers contain a minute amount (1% or smaller) of nitrogen and hydrogen.

The nickel nitrate contained in the polyimide layer is thermally decomposed in the annealing process and becomes Ni particles, and the Ni particles are scattered in the porous layer and fibrous layer. The diameters of the Ni particles are tens nm through hundreds nm. FIG. 4 shows a photograph taken by a scanning electron microscope (SEM) of the produced conductive composite particle.

The conductive composite particles produced in this method are used as electrode material A1 of a non-aqueous electrolyte secondary battery.

### EXAMPLE 2

### Electrode Material B1

Operation similar to that of example 1 is performed except that cobalt nitrate hexahydrate, instead of nickel nitrate hexahydrate, is contained in the polyimide layer.

As a result, Si particles coated with a porous carbon layer and fibrous carbon layer substantially similar to those of example 1 are formed. The formed Si particles are used as electrode material B1 of a non-aqueous electrolyte secondary battery.

### EXAMPLE 3

### Electrode Material C1

A solution where nickel nitrate hexahydrate is dissolved in ion-exchanged water is prepared. The concentration of the nickel nitrate hexahydrate is 1 part by weight per 100 parts by weight of ion-exchanged water. The Si particles used in example 1 are mixed into the nickel nitrate solution and stirred for one hour, and the moisture is removed by an evaporator, thereby making the Si particle surface support nickel nitrate.

The Si particles supporting the nickel nitrate are mixed into the PAA solution, and stirred with a magnetic stirrer. Then, the solution mixed with the particles is moved into a petri dish, and the petri dish is placed in a vacuum drier evacuated by a rotary pump, dried, and heated, thereby transforming the PAA into imide. After imidization, the obtained sheet-like sample is slightly ground with a glass mortar into a powder form. As a result, the Si particles supporting nickel nitrate that are coated with polyimide are obtained.

Then, annealing treatment similar to that of example 1 is performed. As a result, Si particles coated with a porous carbon layer and fibrous carbon layer substantially similar to those of example 1 are formed. The formed Si particles are used as electrode material C1 of a non-aqueous electrolyte secondary battery.

### EXAMPLE 4

### Electrode Material D1

Fine Ni particles whose average diameter is 10 nm are mixed into the PAA solution produced by the same method as example 1, the solution obtained by further adding fine Si particles to the PAA solution is stirred with a magnetic stirrer. Then, the solution mixed with the particles is put into a petri dish, and the petri dish is placed in a vacuum drier evacuated by a rotary pump, dried, and heated, thereby transforming the PAA into imide. After imidization, the obtained sheet-like sample is slightly ground with a glass mortar into a powder form. As a result, the Si particles coated with polyimide in which fine Ni particles are dispersed are produced.

Then, annealing treatment similar to that of example 1 is performed. As a result, Si particles coated with a porous carbon layer and fibrous carbon layer substantially similar to those of example 1 are formed. The formed Si particles are used as electrode material D1 of a non-aqueous electrolyte secondary battery.

### EXAMPLE 5

### Electrode Material E1

Operation similar to that of example 1 is performed except that the thickness of the polymer layer applied to the Si particles is decreased (thickness: 0.1 μm or smaller). As a result, Si particles where the amount of formed carbon layer is smaller than that of example 1 are formed. Especially, the length of the fibrous carbon contained in the carbon layer is shorter than that of example 1. The formed Si particles are used as electrode material E1 of a non-aqueous electrolyte secondary battery.

### EXAMPLE 6

### Electrode Material F1

Operation similar to that of example 1 is performed except that the thickness of the polymer layer applied to the Si particles is increased (thickness: 2 μm or larger). As a result, Si particles where the amount of formed carbon layer is larger than that of example 1 are formed. However, the percentage of the fibrous carbon contained in the carbon layer is smaller than that of example 1. The formed Si particles are used as electrode material F1 of a non-aqueous electrolyte secondary battery.

### EXAMPLE 7

### Electrode Material G1

Operation similar to that of example 1 is performed except that the treatment temperature at which Si particles coated with nickel-nitrate-added polyimide are heated is set at 800° C. As a result, Si particles coated with a porous carbon layer and fibrous carbon layer substantially similar to those of example 1 are formed. The formed Si particles are used as electrode material G1 of a non-aqueous electrolyte secondary battery.

### EXAMPLE 8

### Electrode Material H1

Operation similar to that of example 1 is performed except that the treatment temperature at which Si particles coated with nickel-nitrate-added polyimide are heated is set at 600° C. As a result, Si particles where the amount of formed fibrous carbon layer is slightly smaller than that of example 1 are formed. The formed Si particles are used as electrode material H1 of a non-aqueous electrolyte secondary battery.

### EXAMPLE 9

### Electrode Material I1

Using polyacrylonitrile instead of polyimide as polymer material, a solution is prepared by adding nickel nitrate hexahydrate to polyacrylonitrile. Si particles are mixed into the solution and stirred, and the solvent component is removed by a vacuum drier, thereby providing the Si particles coated with nickel-nitrate-added polyacrylonitrile. The particles are annealed for one hour at 800° C. in an argon (Ar) gas atmosphere.

As a result, Si particles where the amount of formed fibrous carbon layer is slightly smaller than that of example 1 are formed. The formed Si particles are used as electrode material I1 of a non-aqueous electrolyte secondary battery.

### COMPARATIVE EXAMPLE 1

### Electrode Material a1

Operation similar to that of example 1 is performed except that Si particles coated with polyimide having no nickel nitrate are annealed. As a result, the progress degree of carbonization is lower than that of example 1, and Si particles coated with an amorphous carbon film where formation of the porous layer and fibrous layer can be hardly recognized are formed. The formed Si particles are used as electrode material a1 of a non-aqueous electrolyte secondary battery.

### COMPARATIVE EXAMPLE 2

### Electrode Material b1

Operation similar to that of example 1 is performed except that the treatment temperature at which Si particles coated with nickel-nitrate-added polyimide are heated is set at 300° C. As a result, Si particles where the polymer layer is hardly carbonized are formed. The formed Si particles are used as electrode material b1 of a non-aqueous electrolyte secondary battery.

### COMPARATIVE EXAMPLE 3

### Electrode Material c1

100 parts by weight of Si particles and 10 parts by weight of acetylene black (AB) as a conductive agent are dry-mixed. The mixture is used as electrode material c1 of a non-aqueous electrolyte secondary battery.

### COMPARATIVE EXAMPLE 4

### Electrode Material d1

100 parts by weight of Si particles and 10 parts by weight of carbon fiber as a conductive agent are dry-mixed. The mixture is used as electrode material d1 of a non-aqueous electrolyte secondary battery.

### <Evaluation of Electrode Material>

A binder of polyvinylidene fluoride resin (PVDF) and N-methyl-2-pyrrolidone (NMP) is mixed into the electrode materials obtained in examples 1 through 9 and comparative examples 1 through 4, thereby preparing mixture slurry. Each of the slurry is casted on a copper foil (Cu foil) with a thickness of 15 μm, and dried. The Cu foil is then roll-pressed to produce an electrode. The mixture density of the electrode is 0.8 g/cm³ through 1.4 g/cm³.

The electrode is sufficiently dried at 80° C. in an oven to produce a working electrode. The lithium metal foil is used as a counter electrode with respect to the working electrode, and a coin type lithium ion battery is produced so that the working electrode regulates the capacity of the battery. The non-aqueous electrolyte is prepared by dissolving LiPF₆ at a concentration of 1.0 M(mol/L) in the mixed solvent (volume ratio is 1:1) of ethylene carbonate (EC) and diethyl carbonate (DEC) and used.

Regarding the produced coin type lithium ion battery, the initial charge capacity and the initial discharge capacity are measured at a charge-discharge rate of 0.05 C, and the initial charge capacity per active material weight and the charge-discharge efficiency (initial discharge capacity/initial charge capacity) are determined. The ratio of the discharge capacity after charge-discharge is repeated for 50 cycles at the charge-discharge rate of 0.05 C with respect to initial discharge capacity obtained at the same charge-discharge rate is calculated as cycle efficiency (discharge capacity/initial discharge capacity) after 50 cycles). Table 1 shows the result.

TABLE 1

| | | | | | Anneal- | | | | | |
|---|---|---|---|---|---|---|---|---|---|---|
| | | | Added | | ing | | | Discharge | C/D | Cycle |
| | Electrode | Polymer | metal | Adding | temp. | Carbon | Conductive | capacity | efficiency | efficiency |
| | material | material | compound | method | (° C.) | layer | agent | (mAh/g) | (%) | (%) |
| Example | A1 | Polyimide | Ni(NO₃)₂ | Polymer | 1000 | Porous, | Non | 3805 | 87 | 90 |
| 1 | | | | mixing | | fibrous | | | | |
| Example | B1 | Polyimide | Co(NO₃)₂ | Polymer | 1000 | Porous, | Non | 3780 | 84 | 88 |
| 2 | | | | mixing | | fibrous | | | | |
| Example | C1 | Polyimide | Ni(NO₃)₂ | Particle | 1000 | Porous, | Non | 3802 | 86 | 90 |
| 3 | | | | supporting | | fibrous | | | | |
| Example | D1 | Polyimide | Ni | Polymer | 1000 | Porous, | Non | 3795 | 86 | 75 |
| 4 | | | particles | mixing | | fibrous | | | | |
| Example | E1 | Polyimide | Ni(NO₃)₂ | Polymer | 1000 | Porous, | Non | 3805 | 90 | 60 |
| 5 | | | | mixing | | fibrous | | | | |
| Example | F1 | Polyimide | Ni(NO₃)₂ | Polymer | 1000 | Porous, | Non | 3620 | 82 | 80 |
| 6 | | | | mixing | | fibrous | | | | |
| Example | G1 | Polyimide | Ni(NO₃)₂ | Polymer | 800 | Porous, | Non | 3760 | 87 | 89 |
| 7 | | | | mixing | | fibrous | | | | |
| Example | H1 | Polyimide | Ni(NO₃)₂ | Polymer | 600 | Porous, | Non | 3740 | 75 | 58 |
| 8 | | | | mixing | | fibrous | | | | |
| Example | I1 | PAN | Ni(NO₃)₂ | Polymer | 800 | Porous, | Non | 3150 | 82 | 58 |
| 9 | | | | mixing | | fibrous | | | | |
| Comparative | a1 | Polyimide | — | — | 1000 | Film- | Non | 2270 | 50 | 18 |
| example 1 | | | | | | like | | | | |
| Comparative | b1 | Polyimide | Ni(NO₃)₂ | | 300 | Polymer- | Non | — | — | — |
| example 2 | | | | | | like | | | | |
| Comparative | c1 | — | — | — | — | | AB | 2678 | 60 | 5 |
| example 3 | | | | | | | | | | |
| Comparative | d1 | — | — | — | — | — | Carbon | 3120 | 70 | 20 |
| example 4 | | | | | | | fiber | | | |

PAN: polyacrylonitrile, AB: acetylene black, C/D efficiency: Charge/Discharge efficiency

In respective batteries for evaluation including electrode materials A1 through I1 produced in examples 1 through 9, as shown in Table 1, the initial charge capacity per active material weight, the charge-discharge efficiency, and cycle efficiency vary dependently on the added metal compound and the states of the formed porous and fibrous carbon layers. However, these parameters of the samples including one of the conductive composite particles of the present invention are higher than those of electrode material a1 of comparative example 1 that includes neither porous carbon layer nor fibrous carbon layer.

Since neither porous carbon layer nor fibrous carbon layer is formed on the particle surface in comparative example 1, the electron conductive network among the active material particles is gradually disconnected by expansion and contraction of the active material due to charge-discharge. It is considered that the disconnection causes large difference between the cycle characteristics as a result.

The battery for evaluation including electrode material b1 of comparative example 2 where annealing temperature is lower than a predetermined heating temperature does not work as a battery at all. That is because the polymer layer applied to the active material particle is not carbonized and has not conductivity.

In the case employing electrode material c1 of comparative example 3 where acetylene black (AB) is mixed as the conductive agent with the active material particles, only AB as the conductive agent is mixed, and hence the electron conductive network between the active material particles and AB is gradually disconnected by expansion and contraction of the active material due to charge-discharge. It is considered that the disconnection causes large difference between the cycle characteristics as a result.

In the case employing electrode material d1 of comparative example 4 where carbon fibers are mixed as the conductive agent with the active material particles, only carbon fibers as the conductive agent are mixed, and hence the electron conductive network between the active material particles and carbon fibers is gradually disconnected by expansion and contraction of the active material due to charge-discharge. It is considered that the disconnection causes large difference between the cycle characteristics as a result.

There are slight differences between effects of electrode materials A1 through I1 of examples 1 through 9.

Electrode material B1 of example 2 where the added metal compound is different from other examples shows a result of the same level as electrode material A1 of example 1. This result is considered to be caused the fact that the porous carbon layers including the fibrous structure formed on the active material particle are substantially the same.

Electrode material C1 of example 3 where the adding method of the added metal compound is different from other examples shows a result of the same level as example 1 for a similar reason.

In the case employing electrode material D1 of example 4 including fine Ni particles as the added metal compound, reduction in cycle efficiency is observed because the amount of formed fibrous carbon is smaller than that in example 1.

In the case employing electrode material E1 of example 5 where the amount of applied polymer is small, reduction in cycle efficiency is remarkable. That is because the coated amount on the particle is small and hence the disconnection of the electron conductive network between the active material particles by expansion and contraction of the active material due to charge-discharge is apt to occur comparing with example 1.

In the case employing electrode material F1 of example 6 where the amount of applied polymer is large, reduction in discharge capacity and reduction in charge-discharge efficiency are observed. That is because the coated amount on the particle is large and hence the percentage of the active material particles is relatively smaller than that of example 1. Since the percentage of the fibrous carbon is smaller than that of example 1, the disconnection of the electron conductive network between the active material particles by expansion and contraction of the active material due to charge-discharge is apt to occur comparing with example 1.

In the case employing electrode material G1 of example 7 where the annealing temperature is slightly lower, characteristics of a level substantially similar to that of example 1 are obtained. That is because the annealing temperature is included in the heating temperature region allowing a desired carbon layer structure to be formed.

In the case employing electrode material H1 of example 8 where the annealing temperature is further lower, a cycle characteristic is remarkably smaller than that of example 1. The reason is considered as follows. Over lowering of the annealing temperature disturbs sufficient growth of the fibrous carbon layer, so that the disconnection of the electron conductive network between the active material particles by expansion and contraction of the active material due to charge-discharge is apt to occur comparing with example 1.

In the case employing electrode material I1 of example 9 where the polymer material is different from that of other examples, each characteristic smaller than that of example 1 is observed. The reason is considered as follows. The amount of formed carbon layer, the amount of formed fibrous carbon, and the conductivity are smaller than those of example 1, so that the growth of the fibrous carbon layer is insufficient. Therefore, the disconnection of the electron conductive network between the active material particles by expansion and contraction of the active material due to charge-discharge is apt to occur comparing with example 1.

### EXAMPLE ˜10

### Electrode Materials A2 through I2

Operation similar to those of examples 1 through 9 is performed except that silicon particles including a silicon oxide layer are used instead of the silicon particles of each of examples 1 through 9. Similarly, electrode materials a2 through d2 corresponding to comparative examples 1 through 4 are produced.

Example 10 shows a result substantially similar to those of examples 1 through 9. In respective batteries for evaluation including electrode materials A2 through I2, the initial charge capacity per active material weight, the charge-discharge efficiency, and cycle efficiency slightly vary dependently on the added metal compound and the states of the formed porous and fibrous carbon layers. However, these parameters of the samples including a conductive composite particle of the present invention are higher than those of electrode materials a2 through d2 of comparative examples.

### EXAMPLE 11

A negative electrode is produced using electrode material A1 manufactured in example 1, and Li equivalent to irreversible capacity is added to the negative electrode by evaporation.

Then, positive electrode mixture slurry is prepared by mixing the following materials:
100 parts by weight of LiNi_{0.8}Co_{0.17}Al_{0.03}O₂ particles as positive electrode active material;
10 parts by weight of binder made of polyvinylidene fluoride;
5 parts by weight of carbon black; and
an appropriate amount of N-methyl-2-pyrrolidone.

The slurry is casted on an A1 plate with a thickness of 15 μm, and dried. The dried positive electrode mixture is roll-pressed to form a positive electrode mixture layer, and a positive electrode is obtained.

A coin type lithium ion battery is produced using the positive electrode and negative electrode obtained by the above-mentioned methods, and is evaluated similarly to example 1.

According to the evaluation, the initial charge capacity per negative active material weight is 3798 mAh/g, the discharge efficiency is 85%, and the cycle characteristic is 91%.

Evaporation is used as the method of adding Li to the negative electrode in the present example; however, the present invention is not limited to this. For instance, a battery may be assembled after a Li foil is stuck to the negative electrode, or Li powder may be put into a battery case.

As described above, a conductive composite particle of the present invention can be applied to a general active particle used for an electrode of an electrochemical element. Especially, the conductive composite particle is useful as an electrode material of a lithium ion secondary battery and a capacitor that have high initial charge-discharge characteristics and stable cycle characteristics.

What is claimed is:

1. A manufacturing method of a conductive composite particle, the conductive composite particle comprising:
a core section formed of a particle having a region capable of electrochemically inserting and desorbing lithium; and
a surface layer section formed of a carbon layer joined to a surface of the particle, wherein fine particles containing a metal element are dispersed in the carbon layer,
the manufacturing method comprising:
preparing a polymer material that contains the metal element composing the fine particles dispersed in the carbon layer;
coating the surface of the particle with the polymer material containing the metal element; and
forming, as the surface layer section, a carbon layer having a porous structure including a fibrous structure from the polymer material only by a processing treatment, the particle coated with the polymer containing the metal element being heated in an inert atmosphere to carbonize the polymer material in the treatment
(except for a manufacturing method of a conductive composite particle where the fibrous structure is formed by evaporation or deposition after the carbonization).

2. The manufacturing method of the conductive composite particle according to claim 1, wherein
the particle is one of an elemental substance of silicon, tin, and germanium and a compound containing at least one of elements of silicon, tin, and germanium, or a mixture thereof.

3. The manufacturing method of the conductive composite particle according to claim 1, wherein
the compound composing the particle is one of oxide, nitride, oxynitride, and carbide containing at least one of elements of silicon, tin, and germanium.

4. The manufacturing method of the conductive composite particle according to claim 1, wherein
thickness of the polymer material is between 0.05 μm and 10 μm inclusive.

5. The manufacturing method of the conductive composite particle according to claim 1, wherein
the polymer material is aromatic polyimide.

6. The manufacturing method of the conductive composite particle according to claim 1, wherein
the metal element includes at least one of iron, cobalt, nickel, and manganese.

7. The manufacturing method of the conductive composite particle according to claim 1, wherein
the heating temperature is between 400° C. and 1000° C. inclusive.

8. A manufacturing method of a conductive composite particle, the conductive composite particle comprising:
a core section formed of a particle having a region capable of electrochemically inserting and desorbing lithium; and
a surface layer section formed of a carbon layer joined to a surface of the particle, wherein fine particles containing a metal element are dispersed in the carbon layer,
the manufacturing method comprising:
making the surface of the particle support a compound that contains the metal element composing the fine particles dispersed in the carbon layer;
applying a polymer material to the surface of the particle supporting the compound that contains the metal element; and
forming, as the surface layer section, a carbon layer having a porous structure including a fibrous structure from the polymer material only by a processing treatment, the particle coated with the polymer material being heated in an inert gas atmosphere to carbonize the polymer material in the treatment
(except for a manufacturing method of a conductive composite particle where the fibrous structure is formed by evaporation or deposition after the carbonization).

9. The manufacturing method of the conductive composite particle according to claim 8, wherein
the particle is one of an elemental substance of silicon, tin, and germanium and a compound containing at least one of elements of silicon, tin, and germanium, or a mixture thereof.

10. The manufacturing method of the conductive composite particle according to claim 8, wherein
the compound composing the particle is one of oxide, nitride, oxynitride, and carbide containing at least one of elements of silicon, tin, and germanium.

11. The manufacturing method of the conductive composite particle according to claim 8, wherein
thickness of the polymer material is between 0.05 μm and 10 μm inclusive.

12. The manufacturing method of the conductive composite particle according to claim 8, wherein
the polymer material is aromatic polyimide.

13. The manufacturing method of the conductive composite particle according to claim 8, wherein
the metal element includes at least one of iron, cobalt, nickel, and manganese.

14. The manufacturing method of the conductive composite particle according to claim 8, wherein
the heating temperature is between 400° C. and 1000° C. inclusive.
